(19) United States
(12) Patent Application Publication
(10) Pub. No.: US 2003/0054097 A1
(43) Pub. Date: Mar. 20, 2003

(54) Device and method for spinning a liquid sample on a sample carrier

(76) Inventors: Jan Nilsson, Lund (SE); Krister Uvnas, Lund (SE); Goran Stensson, Brosarp (SE); Lars Mclennan, Lund (SE)

Correspondence Address: BURNS DOANE SWECKER & MATHIS L L P, POST OFFICE BOX 1404, ALEXANDRIA, VA, 22313-1404, US

(21) Appl. No.: 10/149,188

(22) PCT Filed: Dec. 13, 2000
(86) PCT No.: PCT/SE00/02512

(30) Foreign Application Priority Data
Dec. 13, 1999 (SE) 9904531-2

(51) Int. Cl. B05C 13/02; B05D 3/12

(52) U.S. Cl. 427/240; 118/52

(57) ABSTRACT

A device for spinning a liquid sample on a sample carrier (2), such as a microscope slide, comprises a rotatable body (4) with a receiving surface (11) for the sample carrier (2), and a chamber (10) for enclosing a sample that has been applied to the sample carrier (2). A means (23) is designed to establish a gas flow from the environment into the chamber (10) in connection with the spinning of the sample in order to prevent leakage of the sample to the environment. Unlike current designs, the chamber (10) is arranged on the same side of the sample carrier (2) as the rotatable body (4). Consequently, the sample carrier (2) itself serves as a cover which seals the chamber (10).

### FIELD OF THE INVENTION

The present invention relates to the spinning of a liquid sample on a sample carrier, such as a microscope slide. The purpose of the spinning can, for example, be to distribute blood in a thin layer on the sample carrier for subsequent examination in a microscope. Alternatively, the purpose of the spinning can be to remove excess stain in connection with so-called staining, which means that a staining solution is applied to and absorbed in a thin blood layer on a sample carrier.

### BACKGROUND ART

A spinning device for distributing blood on a sample carrier is known from DE-25 21 284. The spinning device has a rotatable body with a horizontal receiving surface which is adapted to receive and retain a sample carrier thereon. A driving means is connected to the body for rotating the same. The driving means and the body are arranged in an outer casing, which has a feed opening aligned with the receiving surface of the body. A lid is articulated to the casing for closing the feed opening.

When the device is to be used for distributing blood on a sample carrier, the lid is first opened, after which a sample carrier is introduced through the feed opening and is placed on the receiving surface of the body. A small amount of blood is manually applied to a portion of the sample carrier, after which the lid is closed so that the blood is received in a closed chamber. Subsequently, the body and the sample carrier placed thereon are caused to rotate, whereby the blood is uniformly distributed across the surface of the sample carrier under the influence of centrifugal forces. A problem associated with such a device is that during the spinning the blood can form aerosols, which can escape into surrounding spaces during and subsequent to spinning. This leads to considerable health risks, since the blood may contain contagions, for example hepatitis viruses. Another significant drawback of this known design is that both the handling of the sample carrier and the application of the blood must be carried out manually, resulting in a low rate of production.

### SUMMARY OF THE INVENTION

An object of the present invention is to completely or partly obviate the above-mentioned problems of the prior art. More specifically, an object of the present invention is to provide a device and a method for spinning a liquid sample with minimal risk of spreading aerosols to surrounding spaces.

These and other objects, which will be evident from the description below, have now been achieved by means of a device according to the appended claim 1, as well as a method according to the appended claim 18.

According to a first aspect, the invention thus relates to a device for spinning a liquid sample on a sample carrier, such as a microscope slide, which device comprises a rotatable body with a receiving surface for the sample carrier, and a chamber for enclosing a sample that has been applied to the sample carrier, characterised by a means which is designed to establish a gas flow from the environment into the chamber in connection with the spinning of the sample in order to prevent any leakage of the sample to the environment.

According to a second aspect, the invention furthermore relates to a method for spinning a liquid sample on a sample carrier, such as a microscope slide, in a chamber, comprising the steps of: transporting and applying the sample carrier to a rotatable body, applying the sample to the sample carrier, causing the body to rotate in connection with the application of the sample, and detaching the sample carrier from the body subsequent to the spinning of the sample, characterised by the step of establishing a first gas flow from the environment into the chamber in connection with the spinning of the sample, so that any leakage of the sample from the chamber into the environment is prevented.

Any aerosols remaining in the chamber after spinning could escape into the environment when the sample carrier is detached from the body. By virtue of the fact that a gas flow is established from the environment into the chamber in connection with the spinning of the sample, the chamber is ventilated so that any aerosols can be collected in a controlled manner, for example in a filter between the chamber and the means generating the gas flow.

It is a general advantage of the invention that the device and the method can be used both for distributing blood in a thin layer on a sample carrier and for applying and spinning staining solution on a thin blood layer on a sample carrier, so-called staining. In the latter case, an aerosol of staining solution is generated in the chamber which is permitted to drop onto the sample carrier while the latter is being rotated. The design according to the invention minimises the spreading of stain aerosols, which generally constitute an extreme health hazard, to the surrounding laboratory environment.

Preferred embodiments of the invention, which have special advantages that will be described below, are defined in the dependent claims.

The embodiment according to claim 3 facilitates the application of a sample carrier to the receiving surface of the rotatable body. No mechanical fastening means are required since the sample carrier is retained on the receiving surface by the existing pressure difference.

The embodiment according to claim 4 has the advantage that no gas movements can occur in the chamber when the sample is being applied to the sample carrier. This is particularly important in connection with staining since the aerosol generated by means of a stain sprayer can be applied to the sample carrier without any interference, provided that the chamber is gas tight to the surrounding environment during the application. In addition, the pressure difference between the chamber and the environment will assist in driving the staining solution into the chamber. The embodiment is also important from the point of view of safety, since any leakage between the chamber and the environment automatically leads to a gas flow into the chamber so that any aerosols can be dealt with in a controlled manner.

The embodiment according to claim 5 gives handling advantages. Unlike current designs, the chamber is arranged on the same side of the sample carrier as the rotatable body. The sample carrier thereby serves as a cover that seals the chamber. The design permits automation, since the sample carrier can easily be transported by way of a conveyor to the receiving surface, where it can be lifted and be made to adhere by the negative pressure. When the liquid is distributed on the sample carrier, the latter can, by means of pressure equalisation in the chamber, be detached from the body and fall down onto the conveyor of its own weight.

The embodiment according to claim 6 provides a compact design of the rotatable body. Since the mass of the body is concentrated near its rotation axis, the body can quickly be accelerated to a suitable rotation speed.

The embodiment according to claim 9 ensures that the blood is applied to the centre of rotation of the sample carrier, which has been found to result in the most uniform distribution of the blood in connection with spinning.

### BRIEF DESCRIPTION OF THE DRAWINGS

The invention and its advantages will be described in more detail below with reference to the accompanying schematic drawings, which by way of example show presently preferred embodiments.

FIG. 1 is a part sectional side view of a device according to the invention for distributing blood on a sample carrier.

FIGS. 2a-2g are schematic sectional views illustrating a number of substeps in connection with a method according to the invention for distributing blood on a sample carrier.

FIG. 3 is a part sectional side view of a device according to the invention for applying and spinning staining solution on a sample carrier.

### DESCRIPTION OF PREFERRED EMBODIMENTS

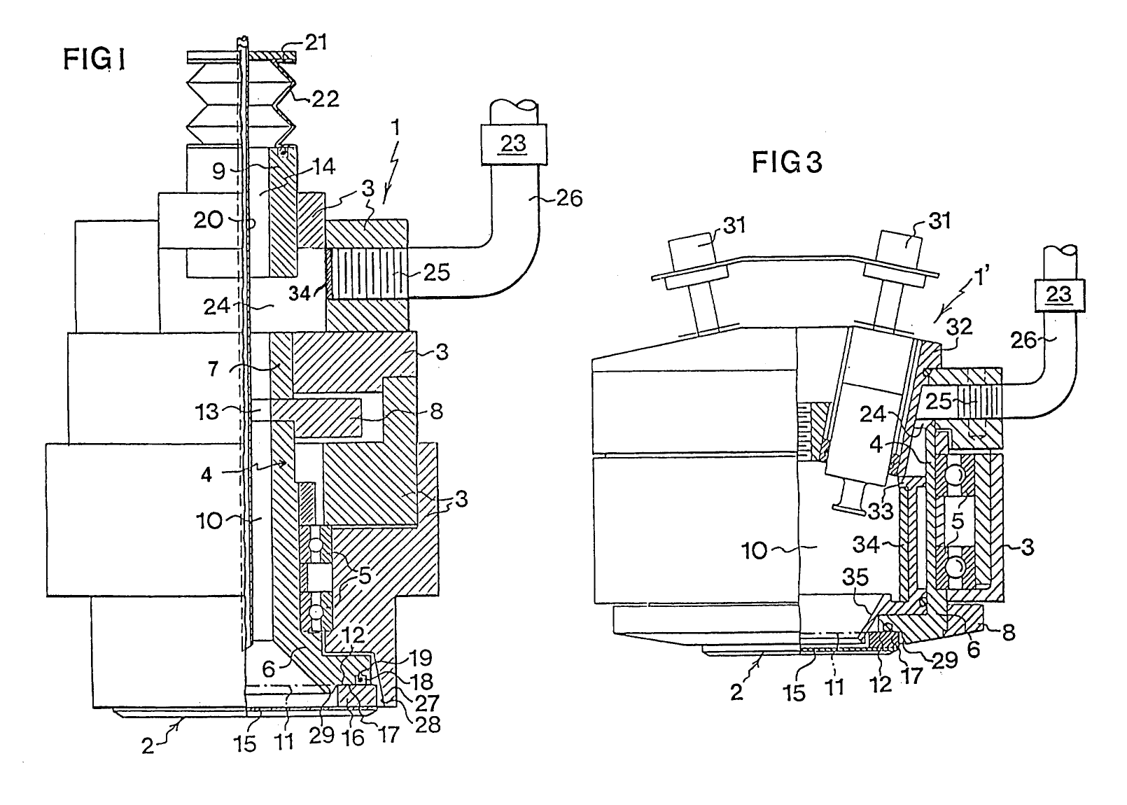

FIG. 1 shows a spinning device 1 according to the invention for distributing blood on a sample carrier 2. The device 1 comprises a rigid outer casing 3 containing an elongated, essentially cylindrical body 4. The body 4 is rotatably supported by means of two bearings 5 which are arranged between the outer surface of the body 4 and the inner surface of the casing 3. The body 4 has a first, widened end 6, which is received within a first opening in the casing 3, and a second end 7, which is fixedly connected to a belt wheel 8. The belt wheel 8 sealingly abuts on an end of a sleeve 9, which is fixedly connected to the casing 3. The other end of the sleeve 9 projects through a second, opposite opening in the casing 3. The body 4 has a central chamber 10, which extends between the two ends 6, 7 of the body 4. At the first end 6 of the body 4, the chamber 10 is widened into the shape of the frustum of a cone and its mouth is located adjacent to a receiving surface 11. The receiving surface 11 comprises an annular surface portion 12, which surrounds the mouth of the chamber 10. The belt wheel 8 and the sleeve 9 have throughgoing channels 13, 14, which are aligned with the chamber 10 in order to form a through-going dosing channel extending between the opposite openings of the casing 3.

The sample carrier 2 shown in FIG. 1 comprises a bottom plate 15, for example a microscope slide, and a circumferential edge 16. The end surface 17 of the edge 16 facing away from the bottom plate 15 is designed for plane engagement with the annular surface portion 12 of the body 4, which surface portion 12 has an annular groove 18 with a seal 19 for sealing against the sample carrier 2 applied to the receiving surface 11. It should be pointed out, however, that the invention is not restricted to any particular design of the sample carrier 2.

A driving means (not shown), such as an electric motor, is connected to the belt wheel 8 by the intermediary of a drive belt (not shown) or equivalent for causing the body 4 to rotate in the casing 3.

A dosing means in the form of a needle 20, which is attached to a robot (not shown), is centrally insertable into the dosing channel by the intermediary of the projecting end of the sleeve 9. The needle 20 has a plate 21 which, when the needle is inserted into the dosing channel by means of the robot, coacts with a bellows 22 arranged on the projecting end of the sleeve 9. This end of the dosing channel is thus sealed against the environment when the needle is introduced into the dosing channel.

The dosing channel is in fluid communication with a negative-pressure-generating-means 23, such as at least one pump or fan, by the intermediary of an opening 24 in the sleeve 9, a threaded coupling 25 in the outer casing 3, and a conduit 26 which is in threaded engagement with the coupling 25 and extends to the negative-pressure-generating-means 23. When the needle is inserted into the dosing channel so that the plate 21 is in sealing engagement with the bellows 22, the dosing channel, as well as the chamber 10, are thus open to the environment at the receiving surface 11 only. Suitable sealing means are suitably arranged in the areas between the outer surface of the sleeve 9 and the inner surface of the casing 3 in order to completely or partly eliminate leakage between these surfaces.

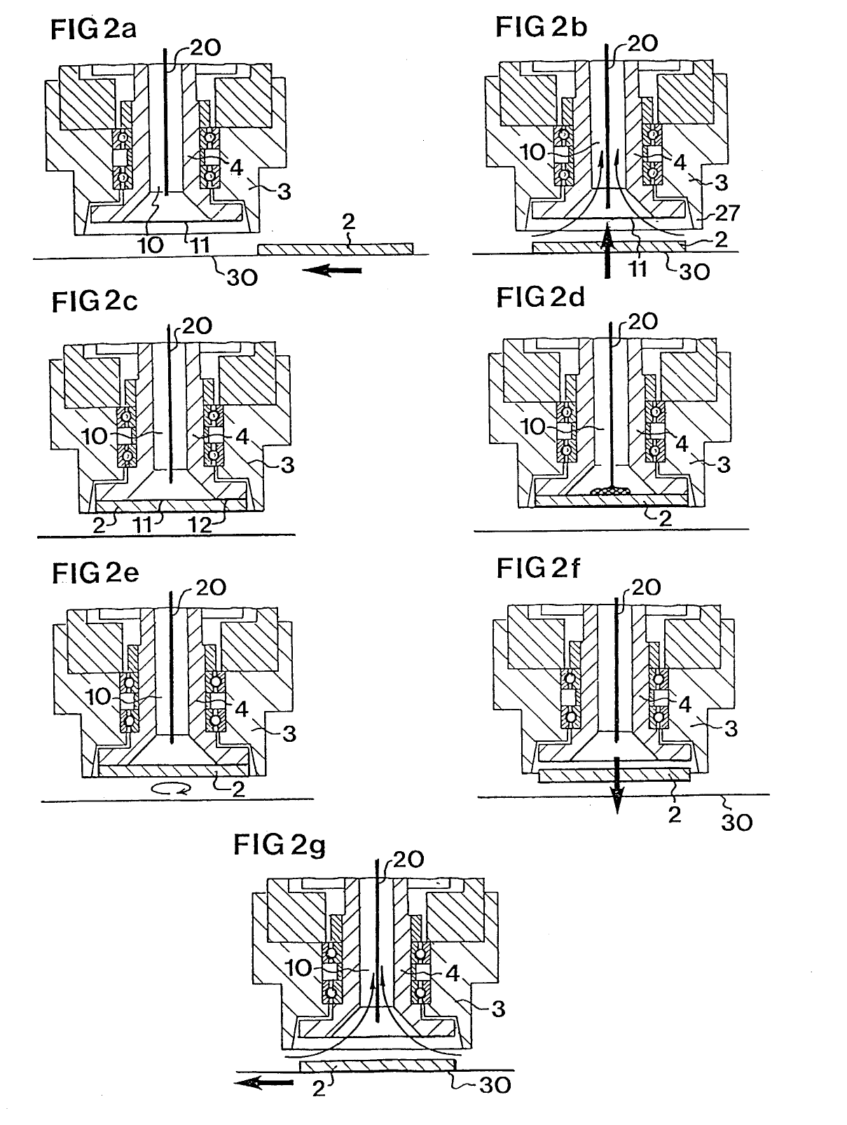

As mentioned above, the receiving surface 11 is recessed in an opening in the casing 3. In this connection the casing 3 forms an annular edge 27 extending around the receiving surface 11. The radially interior surface 28 of the edge 27 is tilting away from the receiving surface 11 for guiding the sample carrier 2 when it is being applied to the receiving surface 11, as will be described in more detail below in connection with FIG. 2. Furthermore, a lug 29 is formed between the annular surface portion 12 of the body 4 and the mouth of the chamber 10, which projects from the receiving surface 11 for guiding the sample carrier 2.

FIGS. 2a-2g show a number of substeps in connection with the operation of a device according to the invention for distributing blood on a sample carrier. Corresponding parts have the same reference numerals as in FIG. 1.

The device according to the invention can be part of a blood analysis machine, in which a sample carrier 2 on a rotatable disc 30, a so-called palette, is transported to the receiving surface 11 of the body 4, as shown in FIG. 2a. In connection with the transportation, the needle 20 is in a retracted position in relation to the receiving surface 11 or, alternatively, completely outside the device 1, for example for refilling with blood. The transportation is interrupted when the sample carrier 2 is aligned with the receiving surface 11. Subsequently, the needle 20 is introduced into the dosing channel so that the plate 21 is in sealing engagement with the bellows 22. Subsequently, the negative-pressure-generating-means 23 is activated so that air from the environment flows into the chamber 10 by the intermediary of its mouth adjacent to the receiving surface 11, see FIG. 2b, and the sample carrier is sucked in towards the receiving surface 11 of the body guided by the edge 27 and the lug 29. When the sample carrier 2 has been sucked against the receiving surface 11 and is in sealing engagement with the annular surface portion 12 of the body 4, a negative pressure is generated in the chamber 10 because the negative-pressure-generating-means 23 is still operating. The needle 20 is then introduced with its point to the vicinity of the sample carrier 2 in order to apply a small amount of blood on the same, as shown in FIGS. 2c-2d. Preferably, the needle 20 extends along the rotation axis of the body 4 in order to ensure that the blood is applied to the centre of rotation of the sample carrier 2. Subsequently, the robot retracts the needle 20, and the body 4 is caused to rotate by the actuation of the driving means. Alternatively, the body 4 can be caused to rotate even before the blood is applied to the sample carrier 2.

The negative pressure in the chamber generated by the negative-pressure-generating-means 23 must be sufficient to retain the sample carrier 2 on the receiving surface 11 during spinning. Normally, the negative pressure in the chamber 10 during spinning is about a 200 mm column of water (2 kPa). This has been found sufficient to enable the sample carrier to be accelerated to about 4500 rpm in about 0.2 seconds. More or less negative pressure can also be used depending on the performance of the device, the friction coefficient between the body 4 and the sample carrier 2, etc.

Typically, the sample carrier 2 is rotated at a speed of 4500 rpm for 1-2 seconds in order to distribute the blood in a thin layer on the sample carrier 2. Subsequently, the driving means is caused to stop the rotation of the body 4, after which the pressure in the chamber 10 is equalised so that the sample carrier 2 will fall down on the rotatable disc 30 of its own weight, as shown in FIG. 2f. Immediately thereafter, the negative-pressure-generating-means 23 is caused to suck air into the chamber 10 from the environment for ventilating the chamber 10. Any aerosols, which may have formed during spinning, are thereby prevented from spreading to surrounding spaces. The aerosols which are sucked into the chamber 10 can, for example, be collected in a filter 34 between the chamber 10 and the negative-pressure-generating-means 23.

The pressure equalisation in the chamber 10 can, for example, be achieved by turning off the negative-pressure-generating-means 23 temporarily, or by opening a valve on the conduit 26 between the body 4 and the negative-pressure-generating-means 23 to the environment, so that the negative-pressure-generating-means 23 is no longer capable of maintaining the negative pressure in the chamber 10.

Alternatively, the chamber 10 could be ventilated before the sample carrier 2 is detached from the body 4, and possibly already during the actual spinning. According to a possible solution (not shown), the body 4 communicates with a valve, which subsequent to and/or during spinning is opened so that ambient air is sucked into the chamber 10 by the active negative-pressure-generating-means 23. When the chamber 10 is ventilated, the sample carrier 2 is detached from the body 4, for example by turning off the negative-pressure-generating-means 23, or by further opening said valve so that the own weight of the sample carrier 2 exceeds the suction forces at the receiving surface 1.

FIG. 3 shows a device 1′ according to the invention for staining a thin layer of blood on a sample carrier. Generally, the device 1′ is used for applying a stain on a sample carrier, which has previously been provided with a thin layer of blood, and for removing excess stain, i.e. staining solution which has not reacted with and been absorbed by the blood layer, by way of spinning. The device 1′ has essentially the same structure as the device 1 according to FIG. 1. Consequently, the same reference numerals indicate like parts in FIG. 3, which will not be described in detail below.

The device 1′ according to FIG. 3 has a dosing means in the form of several stain sprayers 31, which are received in a stain unit 32 and preferably adapted to dose a respective type of staining solution. In some cases, the stain unit 32 can comprise a single stain sprayer 31. The stain unit 32 is detachably mounted in an axial opening in the outer casing 3 in such a way that the stain sprayers 31 discharge into the chamber 10. According to a preferred embodiment, the stain sprayers 31 are symmetrically arranged in the circumference and are directed towards one and the same point, which is preferably located beyond the side of the sample carrier 2 facing the chamber. In this way, each stain sprayer 31 is directed towards a point beside the centre of rotation of the sample carrier 2. This has been found to result in an advantageous distribution of the staining solution on the sample carrier 2.

In comparison with the device 1 in FIG. 1, the chamber 10 of the device 1′ has a considerably larger extent in the radial direction to allow enough room for the stain sprayers to extend to the chamber 10. The belt wheel 8 is fastened to the first end 6 of the body 4, which end 6 projects from the casing 3. Moreover, the guide lug 29 is designed to extend circumferentially around the receiving surface 11. As in FIG. 1, the chamber 10 communicates with the negative-pressure-generating-means 23 by the intermediary of an opening 24 in the body 4, a coupling 25 in the outer casing 3, and a conduit 26 extending to the negative-pressure-generating-means 23.

A filter insert, comprising a filter body 33 and filter material 34 applied thereto, is mounted in the chamber 10. When mounting the filter insert, the stain unit 32 is first removed, whereupon the filter insert is introduced to a non-rotatable engagement with the inside walls of the body 4. According to a preferred embodiment, the filter body 33 has perforations, which are covered by the filter material 34, the filter body 33 being arranged across the outlet from the chamber 10 to the negative-pressure-generating-means 23. The gases which are sucked out of the chamber 10 are thereby forced to pass through the filter material 34 and through holes (not shown) in the upper part of the filter body before reaching the negative-pressure-generating-means 23.

The filter insert has a surface portion extending radially obliquely inwards from the filter material 34 in order to form a circumferential ramp 35. In the mounted state of the filter insert, the ramp 35 discharges adjacent to the receiving surface 11 of the body 4. Staining solution, for example in the form of small drops, which ends up in the area between the sample carrier 2 and the filter material 34 during the application and spinning, will be centrifuged towards the filter material 34 under the influence of centrifugal forces. Staining solution is thereby prevented from running down and destroying the stained layer of blood on the sample carrier 2 subsequent to spinning.

In principle, the device 1′ is operated in the same way as the device 1 according to FIG. 2. One difference, however, is that a staining solution aerosol is generated in the chamber 10 by means of the stain sprayers 31 while the body 4 and the sample carrier 2 are being rotated at a suitable speed, for example 150 rpm. Subsequently, the staining solution is allowed to react with the blood layer on the sample carrier 2, typically for 1-3 minutes. Other time periods can be used depending on the staining solution. Normally, the body 4 is not rotated during this time period. Subsequently, the body is caused to rotate again, typically at a speed of about 3000 rpm, and the body 4 is rotated at this speed for typically 1-2 seconds, for the purpose of removing the staining solution which has not been absorbed by the blood layer.

It is especially preferred that a negative pressure is maintained in the chamber 10 both during the application of the staining solution and during spinning. When the sample carrier 2 is applied to the receiving surface 11, the chamber 10 is completely sealed and gas tight and, consequently, the negative pressure ensures that no gas movements disturb the stain aerosol generated in the chamber 10. In addition, the negative pressure assists in driving the staining solution into the chamber 10. According to a possible embodiment (not shown), the stain sprayers 31 communicate with a respective stain receptacle by the intermediary of a respective conduit. The conduit is filled with staining solution and communicates with the ambient atmosphere by the intermediary of an adjustable throttle valve. When the stain sprayer 31 opens to the chamber 10, in which there is a negative pressure, the pressure difference between the chamber and the environment will drive the staining solution received in the conduit into the chamber 10. Consequently, there is no need for a separate means, such as a pump, for driving the staining solution through the aerosol generating stain sprayer 31.

It will be appreciated that different negative pressures can be established in the chamber 10 during the application and the spinning respectively. Likewise, different gas flows can be established in the chamber 10 during the application of the sample carrier 2 to the receiving surface 11 and during the ventilation of the chamber 10 respectively.

In the illustrated embodiments the chamber 10 is a part of the rotatable body 4 and, moreover, it is rotatable with the same. Alternatively, in particular in a device 1 for distributing blood, the chamber 10 can be a part of a non-rotatable sleeve, which is received in the body 4 and which communicates with the vacuum means 23.

The devices 1, 1′ can also be combined in one and the same device for distributing both blood and staining solution on a sample carrier. In that case, the blood is first distributed on the sample carrier by means of spinning, after which the staining can take place with no intermediate disengagement of the sample carrier from the rotatable body of the device.

The illustrated embodiments have additional advantages. Cross contamination between different samples is essentially completely eliminated since blood or stain residue is efficiently sucked away by means of the vacuum means 23 in connection with the spinning of the sample. In addition, excess stain is absorbed by the filter insert by the fact that the chamber is ventilated by the intermediary of the filter material 34, as well as by the fact that staining solution that ends up outside the sample carrier 2 in the chamber 10 is guided into the filter material 34 by the intermediary of the rotatable ramp 35.

Another advantage is that all driving of the rotatable body 4 can take place above the palette 30. In this way, it is ensured that the driving means of the body 4 is not contaminated with blood or staining solution. Moreover, if the sample carrier 2 is sucked towards the receiving surface 11 with the aid of the negative pressure-generating-means 23, the palette 30 can be made essentially plane, which facilitates cleaning. However, for greater precision, it is conceivable to first mechanically lift the sample carrier 2 and apply it to the receiving surface 11 of the body 4, after which the negative-pressure-generating-means 23 is activated in order to establish the negative pressure in the chamber 10, so that the sample carrier 2 is held in place against the receiving surface 11 during spinning.

As an alternative, the device 1, 1′ shown in FIGS. 1 and 3 respectively can be placed in an enclosing outer receptacle, in which a positive pressure is established relative to the chamber 10 by means of a pump or a fan during said application and/or spinning.

It should furthermore be appreciated that the negative-pressure-generating-means could be used solely for ventilating the chamber and preventing leakage of gases, whereas the lifting of the sample carrier and/or the retention thereof could be carried out with different means, e.g. magnetic means. Conversely, the negative-pressure-generating-means could be used solely for the lifting and/or retention of the sample carrier, whereas the preventing of leakage is carried out by other means.

1. A device for spinning a liquid sample on a sample carrier (2), such as a microscope slide, which device comprises a rotatable body (4) with a receiving surface (11) for the sample carrier (2), and a chamber (10) for enclosing a sample that has been applied to the sample carrier (2), characterised in that the chamber (10) is arranged within the body (4) and has its mouth adjacent to the receiving surface (11), the sample carrier being arranged to be sealingly applied to the receiving surface during the spinning such that said mouth is closed, that the device further comprises a negative pressure-generating means (23) which is designed to establish a gas flow from the environment into the chamber (10) in connection with the spinning of the sample so that the chamber is ventilated and any leakage of the sample to the environment is prevented.

2. A device according to claim 1, wherein said negative pressure-generating means (23) is designed to establish the gas flow subsequent to and/or during the spinning of the sample.

3. A device according to claim 1 or 2, wherein said negative pressure-generating means (23) is adapted to maintain a first negative pressure at the receiving surface (11) for retaining the sample carrier (2) against the receiving surface (11) of the body (4).

4. A device according to any one of claims 1-3, wherein said negative pressure-generating means (23) is designed to maintain in the chamber (10) a second negative pressure relative to the environment during the application of the sample to the sample carrier (2).

5. A device according to any one of claims 1-4, wherein the chamber (10) is integral with the body (4).

6. A device according to any one of claims 1-4, wherein the chamber (10) is formed in a separate unit, which is non-rotatably arranged within the body (4).

7. A device according to any one of the preceding claims, comprising a dosing means (20; 31) for applying the sample to the sample carrier (2), the dosing means (20; 31) being adapted to non-rotatably extend into the chamber (10).

8. A device according to claim 7, wherein the sample is blood and the dosing means (20) is adapted to apply the blood to the sample carrier (2) from a position along the rotation axis of the body (4).

9. A device according to claim 7 or 8, wherein the dosing means (20) comprises at least one needle means which is movable along the rotation axis of the body (4).

10. A device according to claim 9, wherein the sample is a staining solution and the dosing means (31) is designed to generate a staining solution aerosol in the chamber (10).

11. A device according to any one of the preceding claims, comprising a guide means in the form a border (27) extending around the receiving surface (11), whose side facing the receiving surface (11) is tilting away from the receiving surface (11).

12. A device according to any one of the preceding claims, wherein the receiving surface (11) comprises a circumferential seal (19) for sealing against the sample carrier (2) received thereon.

13. A device according to any one of the preceding claims, further comprising a filter (34) which is arranged between the chamber and the negative pressure-generating means (23)for collecting the aerosols from the sample during ventilation.

14. A device according to any one of the preceding claims, wherein the walls of the chamber (10) are completely or partly covered with an absorbing material (34).

15. A device according to claim 14, wherein said means (23) is in fluid communication with the chamber (10) by the intermediary of the absorbing material (34).

16. A device according to claim 14 or 15, wherein a circumferential ramp (35) non-rotatably connected to the body (4) extends between the absorbing material (34) and the receiving surface (11) and has an inclination such that liquid received on the ramp (35) is guided to the absorbing material (34) during spinning.

17. A device according to any one of claims 14-16, wherein the absorbing material (34) and the ramp (35) form a separate insert for mounting in the chamber (10).

18. A method for spinning a liquid sample on a sample carrier (2), such as a microscope slide, in a chamber (10), which is arranged within a rotatable body (4) and which has its mouth adjacent to a receiving surface (11) for the sample carrier on the body, which method comprises the steps of: transporting the sample carrier (2) to the rotatable body (4) and applying the sample carrier (2) sealingly to the receiving surface, applying the sample to the sample carrier (2), spinning the sample by causing the body (4) to rotate in connection with the application of the sample, detaching the sample carrier (2) from the body (4) subsequent to the spinning of the sample, and establishing a first gas flow from the environment into the chamber (10) in connection with the spinning of the sample, so that the chamber is ventilated and that any leakage of the sample from the chamber (10) into the environment is prevented.

19. A method according to claim 18, wherein the first gas flow is established subsequent to and/or during the spinning of the sample.

20. A method according to claim 18 or 19, wherein a second gas flow is established through the body (4) so that the sample carrier (2) transported to the body (4) is caused to move towards the same.

21. A method according to any one of claims 18-20, wherein a first negative pressure is established in the body (4) so that the sample carrier (2) applied to the body (4) is retained against the same.

22. A method according to any one of claims 18-21, wherein a second negative pressure is established in the chamber (10) while the sample is being applied to the sample carrier (2).

23. A method according to any one of claims 18-22, wherein the sample consists of blood, which is applied to the centre of rotation of the sample carrier (2).

24. A method according to any one of claims 18-23, wherein the sample consists of a staining solution, which is generated in the chamber (10) in aerosol form.

25. A method according to claim 24, wherein the staining solution is sprayed towards a point beside the centre of rotation of the sample carrier (2) during the rotation of the sample carrier (2).

26. A method according to any one of claims 18-25, further comprising the step of collecting aerosols from the sample in a filter (34).
